(19) United States
(12) Patent Application Publication
(10) Pub. No.: US 2007/0300178 A1
(43) Pub. Date: Dec. 27, 2007

(54) HANDLING OF SECONDARY POP-UPS OR POP-BEHINDS WITHIN A WEB BROWSER

(76) Inventor: James M. McArdle, Austin, TX (US)

Correspondence Address: MCGRATH, GEISSLER, OLDS & RICHARDSON, PLLC, P.O. BOX 7085, ALEXANDRIA, VA, 22307, US

(21) Appl. No.: 11/425,420

(22) Filed: Jun. 21, 2006

(51) Int. Cl. G06F 9/00

(52) U.S. Cl. 715/781; 715/804; 715/802; 715/808

(57) ABSTRACT

A method and computer program product are disclosed for controlling a software program, such as a web browser, that automatically displays an active window and one or more secondary windows, such as pop-ups or pop-behinds during the viewing of the active window. The user of the software program is provided with the option of controlling the display time of the secondary window by setting the length of time that the secondary window appears on the display of the user. The secondary window automatically disappears from the user's display after expiration of the timeout set by the user.

### BACKGROUND

1. Field

The present embodiments relate generally to web browsers for searching the Internet, and more specifically to methods that assign timeouts to secondary windows such as pop-ups or pop-behinds that are displayed as secondary windows by a web browser.

2. Relevant Art

Conventional web browsers include, for example, Internet Explorer, Netscape Navigator, Firefox, Opera, Safari, Lynx, or the like. Browsing the Internet using one of these conventional web browsers becomes a nightmare as an increasing number of unwanted pop-ups and pop-behinds appear on the user's display.

Pop-ups are usually online advertisements that appear on the World Wide Web as a user browses websites. Pop-ups are mainly intended to increase web traffic or capture email addresses. When a user enters certain web sites, a new web browser window or secondary window is automatically opened to display advertisements on top of or over the active web page which is being viewed. A pop-up window or secondary window containing an advertisement is usually generated by JavaScript, but it can be generated by other means. A variation on the pop-up window is the pop-behind or pop-under window. A pop-behind or pop-under opens a new browser window, behind the active window. Pop-behinds interrupt the user less, because they are not seen until the currently active windows are closed.

Pornographic web sites are among the most common users of pop-up advertisements. Advertisers for these pornographic websites sometimes favor a particularly vicious type of pop-up that spawns multiple windows. As each window is closed by the user, it activates code that spawns another window. This is sometimes called a “Java trap”, “spam cascade” or “Pop-up Hell”. Usually, the only way to stop these annoying pop-ups is to close the browser.

Another variation of pop-up, commonly called “mousetrapping”, fills an entire screen with an ad or web page, in the process removing any menu bars or other on-screen icons by which the user can close the window. This problem mainly affects users of the Windows version of Internet Explorer. Often, access to other open windows and web pages is denied, and the user must terminate the web browser to escape.

Software other than a web browser can also display pop-ups, or can direct the browser to display them. Many spyware programs and advertising-supported software support this function. A different type of pop-up can be sent via the Messenger service in Microsoft's Windows operating system. These pop-ups appear as Windows dialog boxes with a textual message inside, usually directing the user to a web site.

Most web browsers now incorporate popup-blocking tools that allow the user to automatically block pop-ups and pop-behinds. The ease and simplicity of automatically blocking all pop-ups and pop-behinds is desirable, but there are instances when the user may want to allow pop-ups to occur. For example, a website may display a pop-up asking the user to enter a special code to display requested information. Websites sometimes require the user to enter these special codes in order to prevent “bots” or automated software programs from downloading or scraping large amounts of data from the website.

What is needed in the art is the ability to control pop-ups or pop-behinds without forcing the user to choose between automatically allowing all pop-ups or automatically blocking all pop-ups. Providing the user with additional control of pop-ups would greatly enhance the web browsing experience.

### SUMMARY

Embodiments disclosed herein address the above stated needs by providing a pop-up control tool that allows the user to set timeouts for secondary windows displayed by a web browser or other software application. More specifically, the present invention is directed to a method for controlling a software program that displays an active window and a secondary window. The software program allows the automatic opening of the secondary window during the presence of the active window, and it provides a user of the software program with the option of controlling the display of the secondary window. The software also provides a controllable timeout that allows the user to set the length of time that the secondary window appears on the user's display, such that the secondary window automatically disappears from the user's display after expiration of the timeout set by the user.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts an exemplary pop-up window displayed over or on top of a web page;

FIG. 2 depicts an exemplary pop-behind displayed behind or under a web page;

FIG. 3 is a flow chart depicting how the present invention functions; and

FIG. 4 depicts a pop-up window that requires entry of a special code.

### DETAILED DESCRIPTION

The following description of the various exemplary embodiments is illustrative in nature and is not intended to limit the invention, its application, or uses.

Referring now to FIG. 1, an illustration is provided of an active page 11 of a web browser and a secondary window 12 which is known as a pop-up. In FIG. 1, the secondary window 12 or pop-up window is displayed on top of the active page 11. When a user selects an active page to view using an Internet address which is known as a universal resource locator (“URL’), the web server returns to the user an HTML document. In order to display the pop-up 12, the HTML document may inlcude some client-side scripting code (Javascript) that runs as the page is being loaded by the user's browser. The Javascript opens the secondary window 12 or pop-up which may include an objectionable advertisement, such as “Get Rich Quick!”.

To achieve the effect of a pop-up, the Javascript code requests the user's web browser to open the secondary window 12 or windows and load them with content from other URL's. The browser then uses the other URL's to request additional HTML documents to be displayed. In the case of some pop-ups, the Javascript code has a delayed response built in which causes it to wait a few seconds before requesting a new window. This delay may fool the browser pop-up blocking code which relies on the concept of immediate pop-ups or concurrently loaded pop-ups. Accordingly, even if a pop-up blocker is employed by the user, there is a possibility that an undesired pop-up may still be displayed.

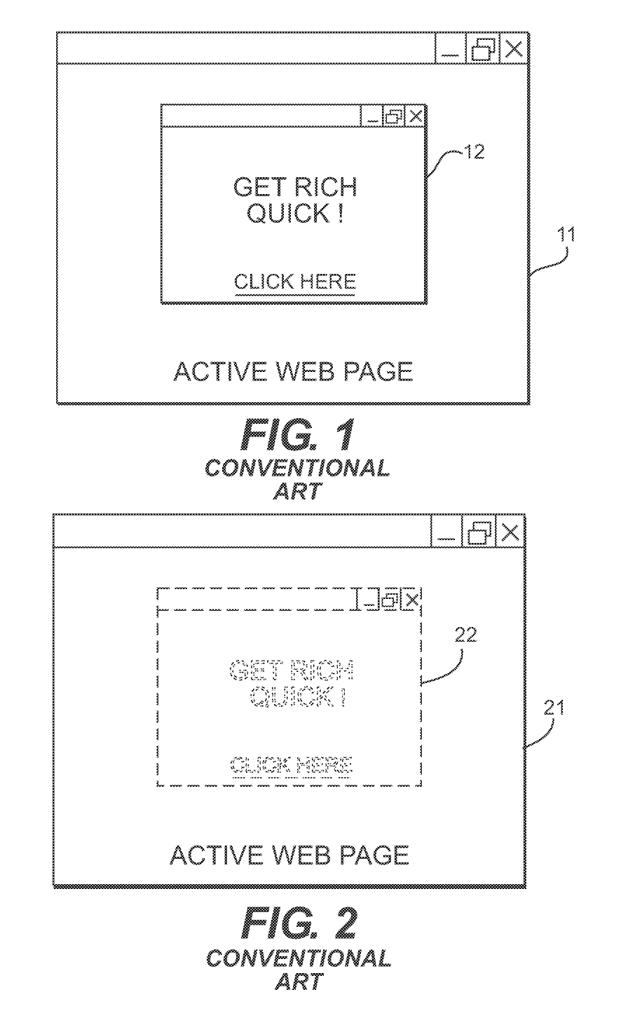

In addition to pop-ups which are displayed on top of or over the active page, there are also secondary windows which are known as pop-behinds or pop-unders. Referring now to FIG. 2, an illustration is provided of an active page 21 of a web browser and a secondary window 22 or pop-behind. Instead of the secondary window 22 appearing on top of the active page 21, the pop-behind or secondary window 22 is not visible to the user until the active window 21 is closed.

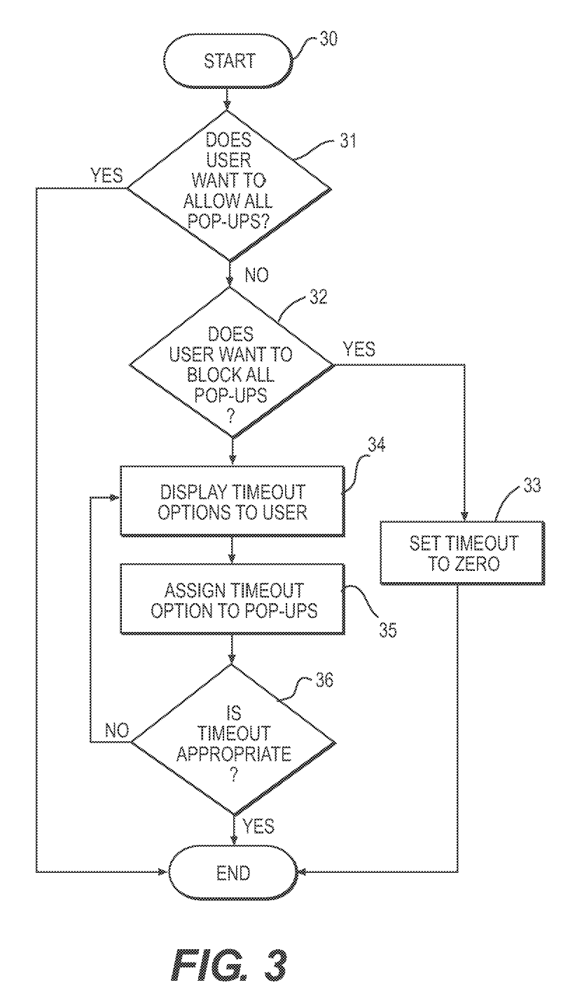

Referring now to FIG. 3, a flow diagram illustrates how the pop-up controls of the present invention can be set by the user who initiates a software program or web browser in step 30. When the software program or web browser is initiated the user has the option of allowing all pop-ups or secondary windows in step 31. If the user determines that all pop-ups or secondary windows are permitted, then the features of the present invention are not utilized. If the user, however, determines in step 32 that pop-ups or secondary windows should be controlled in accordance with the present invention, the user is provided with the option of setting a timeout. This option preferably appears to the user as one of the web browser options that are included in virtually all web browsers. If the timeout option is set to zero in step 33, then all pop-ups are blocked. If the user decides to control the length of time that pop-ups are displayed, then the user is provided with a timeout setting option in step 34. The user assigns a timeout to the secondary windows or pop-ups in step 35. If during the use of the web browser, the user decides that the display of the secondary windows is inadequate, then the user can set a more appropriate timeout in step 36.

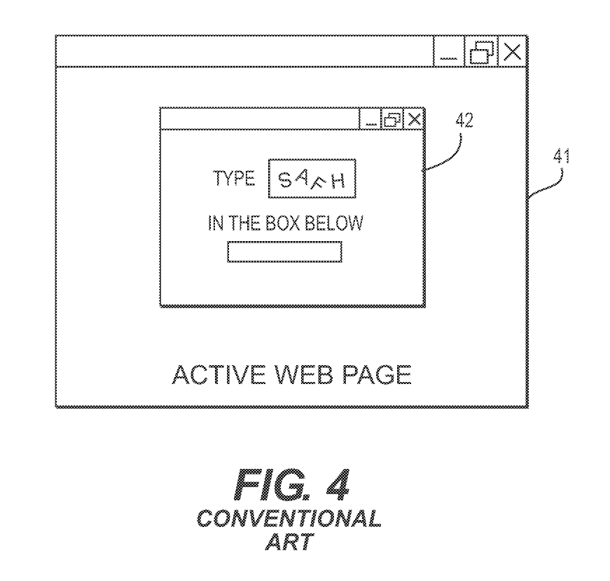

The user, for example, may decide that the timeout option is inadequately short when visiting a website that utilizes a secondary window to enter codes that defeat “bots” or automated software programs that download or scrape data from websites. In order to prevent data scraping, a website may require the user to enter a CAPTCHA which is an acronym for Completely Automated Public Turing test to tell Computers and Humans Apart. This technique identifies the party trying to access the site as a human or a computer program, by generating questions that only a human can answer correctly. Such a secondary window or pop-up 42 is illustrated in FIG. 4. In FIG. 4 the active webpage 41 is overwritten with a pop-up 42 having a CAPTCHA. The CAPTCHA, for example, may open the secondary window or pop-up 42 that displays distorted images of a fictitious word and challenges the party to correctly enter the fictitious word. The user may want to permit the opening of such secondary windows or pop-ups 42, and the present invention provides the user with a convenient tool that allows the opening of such secondary windows for a reasonable length of time.

In order to control the length of time that the pop-ups 12, 42 or pop-behinds 22 are visible to the user, the present invention modifies the web browser code. Web browsers include code that knows which windows are opened, and web browsers are capable of tracking the open windows. Accordingly, the web browser code is modified to display the tracked windows for a predetermined time. If a plug-in is utilized to control the display time of the secondary windows in accordance with the present invention, the plug-in would have to have hooks to know which windows are open, and it would have know the identities of the secondary windows in order to manipulate them. In order to implement the invention in different web browsers, such as Internet Explorer, Safari, Mozilla or Firefox, each browser would require different API calls. In addition to performing the control of secondary windows on the client side with modified code or a plug-in, another approach to control secondary windows would be to use a server-side application that would rewrite the HTML code by adding in timeouts for the secondary windows or pop-ups.

In order to modify existing web browsers, it should not be difficult to modify the code. At the point where the web browser decides to open a new window, the web browser code is preferably modified to record the identity of a window and to set a timer, if the window request is from a secondary window in the webpage which is being downloaded. It should probably require no more than fifty lines of code to modify a browser to have this feature. The web browser code preferably records the secondary window identity into a table, and there is a separate timer thread which is monitored every 1/10th of a second to determine if any secondary window needs to be closed. The identity of the closed secondary window is then removed from the table. The thread can terminate or go to sleep, if the table is empty. This modification to the code could be by a third party or the owner/author of the web browser code. A third party could modify the code using a web browser plug-in, and owner/author of the code could directly modify the web browser code to incorporate the features of the present invention.

One of the advantages of the present invention is that an Internet advertiser cannot easily override the timeout feature. Since the present invention is preferably implemented in the web browser on the client side, there is little that an Internet advertiser can do to defeat the timeout. One of the tricks that Internet advertisers have used against the Firefox browser is a delayed secondary window opening. Firefox blocks secondary windows or pop-ups that open simultaneously with opening of the primary or active webpage. However, if the opening of the secondary window is delayed, the Javascript code within the page can request that Firefox display another window and URL after a predetermined time, thereby defeating the pop-up blocker. In the present invention, however, the window opening code is modified to make all secondary windows limited to a time limit that is measured from the beginning of the opening of the secondary window and not from the opening of the primary or active window.

Preferably the option to set the timeout for the secondary window would appear as a part of the browser options/properties dialog. Accordingly, in addition to clearing the cache or setting no cookies mode, the user can preferably set the secondary window timeouts as a user selectable function in a pull down menu or dialog box.

The use of the word “exemplary” in this disclosure is intended to mean that the embodiment or element so described serves as an example, instance, or illustration, and is not necessarily to be construed as preferred or advantageous over other embodiments or elements. The term “web browser”, as used herein, is intended to mean any software application or routine that submits data (e.g., in response to a user action or input) over the Internet and gets a response. The term “pop-up” means any secondary window displayed by a web browser or other software application, and the term “pop-up” includes any secondary window displayed on, over, under or behind an active window. The description of the invention provided herein is merely exemplary in nature, and thus, variations that do not depart from the gist of the invention are intended to be within the scope of the embodiments of the present invention. Such variations are not to be regarded as a departure from the spirit and scope of the present invention.

What is claimed is:

1. A method for controlling a software program that displays an active window and a secondary window, the software program allowing the automatic opening of the secondary window during the presence of the active window, comprising:
providing a user of the software program with the option of controlling the display of the secondary window; and
providing a controllable timeout that allows the user to set the length of time that the secondary window appears on the user's display;
wherein the secondary window automatically disappears from the user's display after expiration of the timeout set by the user.

2. A method according to claim 1 wherein the controllable display time of the secondary window is set to have a timeout between zero or a predetermined length set by the user.

3. A method according to claim 2 wherein the secondary window is a pop-up window that displays on top of the active window.

4. A method according to claim 2 wherein the secondary window is a pop-behind window that displays behind the active window.

5. A method according to claim 2 wherein the software is a web browser and the option to control the display of secondary windows is made available to the user via an options menu.

6. A method according to claim 1 wherein the software program includes a table having the identity of all open windows and the table is periodically checked to close any secondary window having a timeout that has been exceeded.

7. A method according to claim 1 wherein all secondary windows are blocked when the timeout is set to zero.

8. A method according to claim 1 wherein the timeout is set from the beginning of the opening of the secondary window.

9. A method according to claim 1 wherein the timeout is set by a server-side application that rewrites the HTML code of the active window by adding in timeouts for the secondary windows.

10. A computer program product comprising a computer useable medium including a computer readable program, wherein the computer readable program when executed on a computer causes the computer to:
provide a user of the computer program product, having an active window and a secondary window that is automatically opened, with the option of controlling the display of the secondary window; and
provide a controllable timeout that allows the user to set the length of time that the secondary window appears on the user's display;
wherein the secondary window automatically disappears from the user's display after expiration of the timeout set by the user.

11. A computer program product according to claim 10 wherein the controllable display time of the secondary window is set to have a timeout between zero or a predetermined length set by the user.

12. A computer program product according to claim 11 wherein the secondary window is a pop-up window that displays on top of the active window.

13. A computer program product according to claim 11 wherein the secondary window is a pop-behind window that displays behind the active window.

14. A computer program product according to claim 11 wherein the software is a web browser and the option to control the display of secondary windows is made available to the user via an options menu.

15. A computer program product according to claim 10 wherein the software program includes a table having the identity of all open windows and the table is periodically checked to close any secondary window having a timeout that has been exceeded.

16. A computer program product according to claim 10 wherein all secondary windows are blocked when the timeout is set to zero.

17. A computer program product according to claim 10 wherein the timeout is set from the beginning of the opening of the secondary window.

18. A computer program product according to claim 10 wherein the timeout is set by a server-side application that rewrites the HTML code of the active window by adding in timeouts for the secondary windows.
